(19) United States
(12) Patent Application Publication
(10) Pub. No.: US 2016/0131481 A1
(43) Pub. Date: May 12, 2016

(54) MEMS INERTIAL SENSING USING ACOUSTIC WAVES

(71) Applicant: Hao Luo, Milpitas, CA (US)

(72) Inventor: Hao Luo, Milpitas, CA (US)

(21) Appl. No.: 14/934,669

(22) Filed: Nov. 6, 2015

Related U.S. Application Data
(60) Provisional application No. 62/077,059, filed on Nov. 7, 2014.

(51) Int. Cl. G01C 19/5698

(52) U.S. Cl. CPC G01C 19/5698

(57) ABSTRACT

A MEMS structure includes a generating diaphragm, one or more wave channels, and one or more sensing diaphragm. A method for inertial sensing comprises driving the generating diaphragm to generate an acoustic wave, passing the acoustic wave through a channel in the MEMS structure to the sensing diaphragm, and measuring a relative phase of the wave at the sensing diaphragm to determine acceleration or rotation of the MEMS structure.

### CROSS-REFERENCE TO RELATED APPLICATIONS

This patent document claims benefit of the earlier filing date of U.S. provisional Pat. App. No. 62/077,059, filed Nov. 7, 2014, which is hereby incorporated by reference in its entirety.

### BACKGROUND

Many modern systems, particularly those employed by the automotive industry and in consumer electronics, use microelectromechanical systems (MEMS), such as accelerometers and gyroscopes. In particular, MEMS inertial sensors commonly utilize an amplitude modulation capacitive sensing method that employs at least one miniaturized comb drive. The comb drive includes two sides, where each side has multiple comb fingers attached, and the comb fingers on the two sides are interdigitated and form a capacitor. A comb drive is a basic structure in many MEMS devices for either capacitive sensing or actuation. Comb drives may be utilized with one side attached to a moveable portion of the MEMS device such as a proof mass gimbaled by a spring while the other side of the comb drive is attached to a non-moveable portion of the MEMS device such as an anchor. During movement of the device, inertia and relative mobility of the proof mass causes the relative position of the two sides of the comb drive to change, which changes the capacitive coupling between the two sides. The capacitance variation caused by the position changing can be sensed electronically. An example of such a device is an accelerometer which includes a proof mass, a spring beam, and a sensing comb drive. When the device experiences acceleration, the proof mass moves along with one side of the comb drive, and the acceleration can be detected by measuring the comb drive capacitance variation.

A comb drive can also be used as an electrostatic actuator by applying different voltages to the two sides of the comb drive. Electrostatic force can cause two sides to attract each other. One application of such actuation can be found in a vibratory gyroscope. The proof mass of a vibratory gyroscope may be driven into oscillatory motion by applying alternating voltage to the comb drive. When the gyroscope rotates, a Coriolis force may arise in a direction orthogonal to the proof mass oscillation direction. Similar to the accelerometer, rotation can be sensed by measuring the capacitance changing, which the orthogonal Coriolis force causes.

The actuation and sensing of a MEMS gyroscope can also be implemented using a piezoelectric method. An example of such a device utilizes piezoelectric material in place of a comb drive for driving and sensing. Due to the piezoelectric effect, a varying applied voltage can cause the piezoelectric material to expand or contract. Thus, the force generated by the piezoelectric effect can drive the proof mass into oscillation, and the resulting Coriolis force can also generate voltage across the piezoelectric material in a sensing direction. Thus, rotation can be sensed by measuring the voltage change in the sensing piezoelectric element.

These conventional inertial sensing devices detect the motion, either acceleration or rotation, by measuring a sensing voltage amplitude change that the motion of a proof mass amplitude modulates. The amplitude of the device motion, acceleration or rotation, transforms the amplitude of sensing voltage. However, this amplitude modulation (AM) method has disadvantages of complexity in device fabrication, sensitivity to mechanical stress, and difficulty in measuring small signals. Since AM is prone to a high level of noise, which is common in electrical circuits, AM sensing devices may be unable to provide low-noise measurements.

### SUMMARY

A MEMS inertial sensor can measure inertial force using acoustic waves. The MEMS device may be fabricated with micro fabrication methods to create a sensor containing an acoustic wave generator, an acoustic wave channel, and an acoustic wave sensor. In one configuration, the acoustic wave generator in a MEMS device includes at least one diaphragm, which can be driven into motion by piezoelectric, electrostatic, magnetic or thermodynamic methods. The vibration of the diaphragm may, for example, generate an acoustic wave having a frequency in the kilohertz to gigahertz range, e.g., from tens of kilohertz to one or more megahertz. An acoustic wave generated at the diaphragm may travel through one or multiple acoustic wave channels and reach one or more diaphragms that act as the acoustic wave sensor. When the MEMS device accelerates or rotates, the speed of the acoustic wave relative to the MEMS device changes because inertia causes fluid in the channel to accelerate or rotate more slowly than does the MEMS device, and the change in relative speed causes the phase of the acoustic wave to shift. In particular, the channel fluid may move relative to the sensing diaphragm so that the effective wave path length changes, which changes the wave's phase at the sensing diaphragm. The resulting phase shift of the sensed wave compared to the generated wave, or more specifically the change in or derivative of the phase shift, may indicate the acceleration or rotation of the MEMS device.

One implementation disclosed herein is a structure such as a MEMS inertial sensor that includes an acoustic wave generator, a wave channel, and an acoustic wave sensor. Various embodiments may differ according to how the acoustic wave is generated, the paths of the channels inside the device, or how the acoustic wave is sensed.

Another implementation disclosed herein is a fabrication process to make such structures.

### BRIEF DESCRIPTION OF THE DRAWINGS

FIG. 1 shows a cross sectional view of an embodiment of a MEMS structure using a piezoelectric material in an actuating diaphragm and a sensing diaphragm.

FIG. 2 shows a cross sectional view of an embodiment of a MEMS structure with electrostatic acoustic wave generation and sensing.

FIG. 3 shows a top view of an embodiment of a MEMS structures with a single straight acoustic wave channel.

FIG. 4 shows a top view of an embodiment of a MEMS structure with two co-linear acoustic wave channels.

FIG. 5 shows a top view of an embodiment of a MEMS structure with curved or semi-circular acoustic wave channels.

FIG. 6 shows a top view of an embodiment of a MEMS structure with multiple rectangular spiral acoustic wave channels and multiple sensing diaphragms.

FIGS. 7A and 7B illustrate circuitry for generating and sensing acoustic waves that respectively traverse the wave channel configurations of FIGS. 2 and 3.

FIGS. 8A and 8B illustrate acoustic wave traveling modes respectively for the wave channel configurations of FIGS. 5 and 6.

FIGS. 9A, 9B, and 9C show cross-sections of structures created during a process for fabricating a cap or diaphragm plate of a piezoelectric MEMS.

FIGS. 9D and 9E show cross-sections of structures created during a process for fabricating a channel substrate of a piezoelectric MEMS.

FIG. 9F shows a cross-section of the piezoelectric MEMS structure when a diaphragm plate and a channel substrate are joined.

FIGS. 10A, 10B, 10C, and 10D show cross-sections of structures created during a process for fabricating a cap or diaphragm plate of a MEMS using electrostatic wave generation and sensing.

FIG. 10E show cross-sections of a channel plate for the electrostatic MEMS structure.

FIG. 10F shows a cross-section of the electrostatic MEMS structure when the diaphragm plate and the channel plate are joined.

The drawings illustrate examples for the purpose of explanation and are not of the invention itself. Use of the same reference symbols in different figures indicates similar or identical items.

### DETAILED DESCRIPTION

One or an assembly of MEMS structures can be directly fabricated in or on silicon or other substrates to contain acoustic wave generating and sensing diaphragms and an acoustic wave conducting channel between the generating and sensing diaphragms. In the following description, numerous specific details are set forth, such as processing steps, in order to provide a thorough understanding of example implementations of the present invention. It will be apparent to those skilled in the art that various embodiments of the present invention may be practiced without the specific details as described. In other instances herein, well-known steps, such as lithography and etching, are not described in detail in order to not unnecessarily obscure the description of the disclosed implementations. Furthermore, it is to be understood that the various embodiments shown in the figures are illustrative representations and are not necessarily drawn to scale.

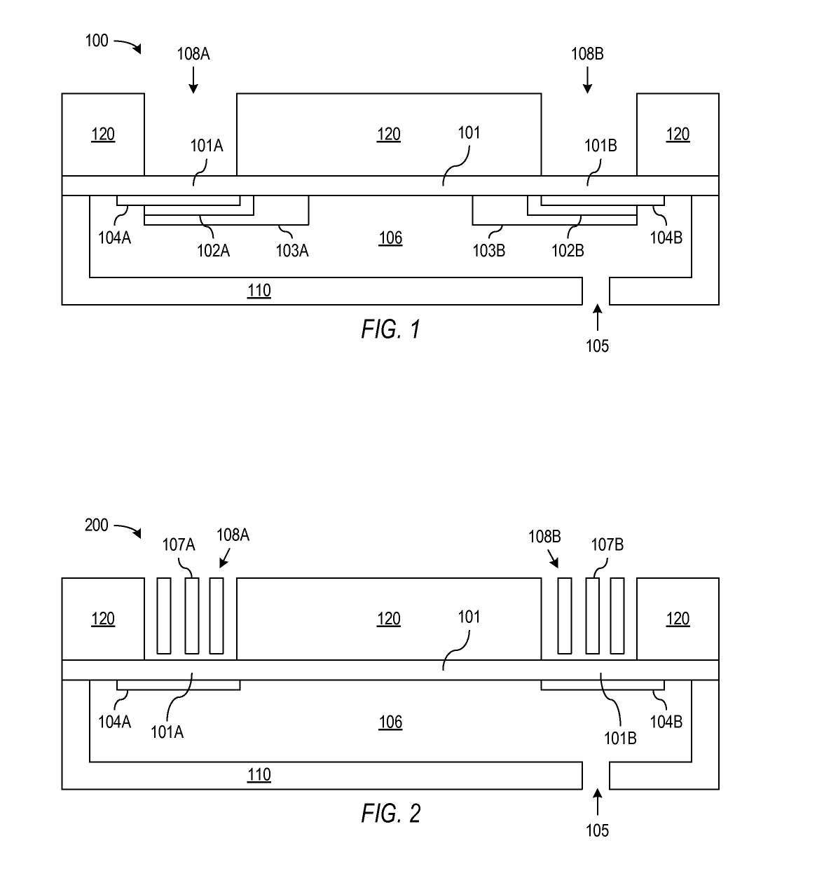

FIG. 1 shows a cross-sectional view of a MEMS device 100 in accordance with one embodiment of the invention. MEMS device 100 includes a bottom or channel substrate 110, a cap plate 120, and a diaphragm 101 between substrate 110 and cap plate 120. Both substrate 110 and cap plate 120 can be made of a semiconductor, a dielectric, and a metal, or any material that can be etched to create the illustrated features or contours. For example, cap plate 120 has etched openings 108A and 108B adjacent to diaphragm areas 101A and 101B, which allow areas 101A and 101B of diaphragm layer 101 to deflect or vibrate, while cap plate 120 holds diaphragm layer 101 fixed elsewhere.

Diaphragm 101 can be made from semiconductor, dielectric, metal and metal alloys, or combinations of these. In one specific implementation, diaphragm layer 101 is a silicon nitride layer about 0.1 μm to 50 μm thick, and diaphragm areas 101A and 101B are about 1 to 400 μm in diameter or width. A thin region 104A of electrode material, e.g., a metal such as, Cu, Al, Ag, Ti, W, Au, Pt, Ni, Zn or an alloy of such metals, is on a bottom side of the diaphragm 101 approximately under opening 108A, e.g., on area 101A. A thin region of piezoelectric material 102A, e.g., Aluminum Nitride (AlN), Lead Zirconate Titanate (PZt), Zirconium Oxide (ZrO₂), Silicon Carbide (SiSiC/SSiC), Silicon Nitride(Si₃N₄), Silicon Alumina Nitride (SiAlON), or Aluminum Titanate(Al₂TiO₅), is on the surface of electrode 104A. Another thin region 103A of electrode material is deposited on the other side of piezoelectric region 102A, so that piezoelectric region 102A is sandwiched between electrode regions 103A and 104A. The thicknesses of layers 102A, 102B, 103A, 103B, 104A, and 104B may be selected according to the particular material use for the layers, but in general, the layers should be thin enough to deflect in response to an applied drive force or in response to pressure changes caused by an acoustic wave. In particular, when voltage is applied between electrodes 103A and 104A, piezoelectric material 102A expands or contracts which can cause diaphragm 101 to deflect in area 101A. Applying an AC voltage signal between electrodes 103A and 104A can thus cause diaphragm area 101A to generate an acoustic wave, which may, for example, have a frequency in a range from kilohertz to Gigahertz range.

A vessel 106 is etched in substrate 110 to provide cavities under areas 101A and 101B and to provide one or more acoustic wave conducting channels connecting the cavities under areas 101A and 101B. Vessel 106 contains a fluid such as air and so that an acoustic wave in the fluid can pass between diaphragm area 101A (sometimes referred to herein as generating diaphragm 101A) and diaphragm area 101B (sometimes referred to herein as sensing diaphragm 101B). The shape, width, and depth of vessel 106 will generally depend on the desired overall area of the MEMS device and on the desired channel length between areas 101A and 101B. In a typical example, the channel provided by vessel 106 may, for example, be about 1 to 200 micrometers wide and deep, but more generally, a device using the principles disclosed herein may use larger channels of any size that fits within the device. In general, a wider and deeper channel may tend to reduce surface effects that reduce inertial effects on the fluid within the channel.

Sensing diaphragm 101B similarly includes piezoelectric structure, e.g., conductive electrode regions 103B and 104B sandwiching piezoelectric region 102B, which may be fabricated on area 101B of diaphragm 101 under opening 108B in cap plate 120. Diaphragm area 101B is sufficiently flexible and free to deflect when acoustic wave pressure from a wave traversing vessel 106 reaches diaphragm area 101B. The deflection generates a voltage difference between opposite sides of piezoelectric region 102B, and the voltage difference thus generated provides an electric signal that may be processed by electronics (not shown), which may be fabricated in and on cap plate 120, diaphragm 101, or substrate 110 or in a device separate from MEMS device 100.

Vessel 106 may have one or more vents 105, which may be etched through bottom substrate 110 as shown in FIG. 1. As described further below, phase differences measured using MEMS device 100 may depend on motion of MEMS device 100 that causes air or other fluid in vessel 106 to have a velocity relative to sensing diaphragm 101B. Vents 105 may be designed to reduce forces that the MEMS device 100 applies to the fluid in vessel 106 when MEMS device 100 moves. For example, air may be free to move into vessel 106 through one vent 105 and out through another vent 105, so that acceleration of MEMS device 100 does not cause pressure to build at one end of vessel 106 that might otherwise cause acceleration of the air in vessel 105 to be closer to the acceleration as MEMS device 100.

FIG. 2 shows a cross-sectional view of an embodiment of a MEMS structure 200 that uses electrostatic actuation and sensing. For electrostatic actuation, an electrode region 104A is under opening 108A in cap plate 120 and under diaphragm 101 in area 101A. Opening 108A for this embodiment includes one or more regions 107A of cap plate 120 that are above electrode region 104A and separated from diaphragm 101 to allow diaphragm area 101A to move toward or away from regions 107A. Regions 107A may be conductive portions of cap plate 120 or may include an electrode region or regions (not shown) residing on an underside of one or more regions 107A. When an applied voltage difference between regions 107A and electrode 104A varies, electrostatic attraction of electrode 104A to regions 107A varies and may cause acoustic vibrations of diaphragm area 101A. Similarly, a capacitive sensing may be implemented using an electrode 104B under diaphragm 101 in area 101B of opening 108B, and cap plate 120 includes one or more regions 107B in opening 108B, over and separate from diaphragm 101. When acoustic pressure causes area 101B of diaphragm 101 to move up or down in opening 108B, the capacitance between electrode 104B and conductive portions of regions 107B changes, and the change in capacitance can be electrically measured to sense changes in acoustic pressure. For example, a capacitive sensing circuit, such as a charge sensing amplifier, can generate an electrical signal with an amplitude proportional to the capacitance of an electrostatic sensing diaphragm.

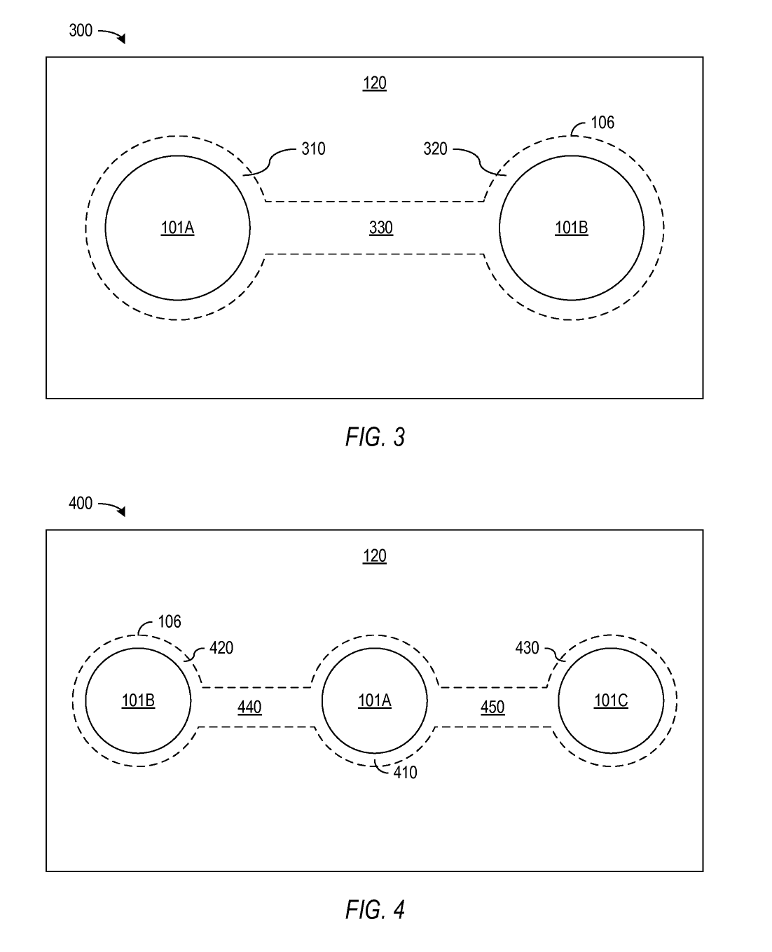

FIG. 3 shows a top view of an embodiment of a MEMS structure 300 and the outline of a vessel 106 with a single straight acoustic wave conducting channel 330 that connects a cavity 310 associated with the diaphragm area 101A for the acoustic generator and a cavity 320 associated with the diaphragm area 101B for the acoustic sensor. The acoustic generator or acoustic sensor may be implemented in diaphragm areas 101A or 101B using piezoelectric or capacitive effects described above or any other technology suitable for use in MEMS devices. For example, an acoustic wave generator may employ a magnetic drive system and a thermodynamic drive system to drive movement of diaphragm 101A.

FIG. 4 shows a top view of an embodiment of a MEMS structure 400 with an acoustic vessel 106 including two straight acoustic wave conducting channel segments 440 and 450. In the illustrated configuration of FIG. 4, acoustic channel segment 440 connects a cavity 410 under the diaphragm region 101A, which is associated with an acoustic generator, to separate cavities 420 and 430 under diaphragm regions 101B and 101C, which are associated with two distinct acoustic sensors. The configuration of vessel 106 of FIG. 4, has two channel segments 440 and 450 that are co-linear or along the same line or axis and can be used to measure acceleration in a direction along that line or axis. If desired, vessel 106 may have channel segments that head in different directions to sensing diaphragms that may be used to measure acceleration in different directions, e.g., to sense different components of an acceleration vector.

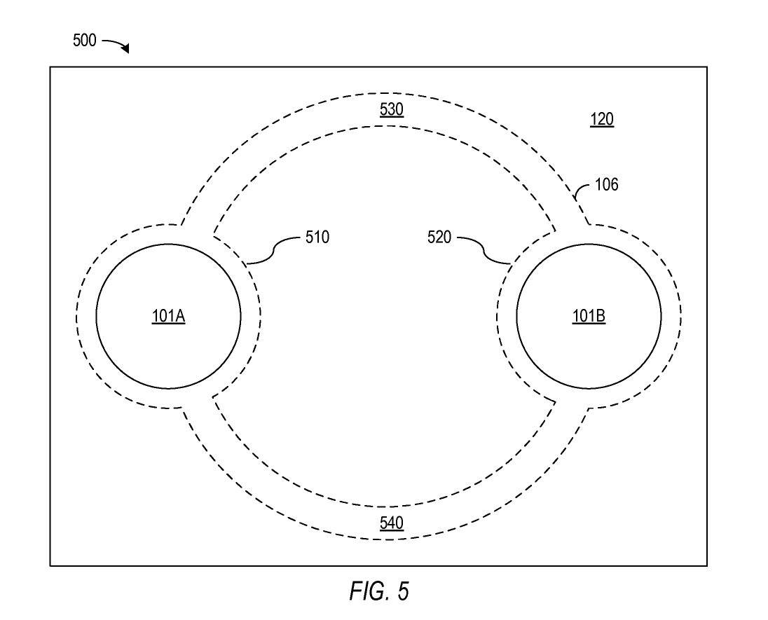

FIG. 5 shows a top view of the an embodiment of a MEMS structure 500 with semi-circular acoustic wave conducting channel sections 530 and 540 connecting an actuator cavity 510 to a sensor cavity 520. The curved paths 530 and 540 shown in FIG. 5 may allow a longer channel within a smaller area for MEMS device 500. The configuration of FIG. 5 may particularly be used for sensing rotation of MEMS device 500 about an axis perpendicular to the area of MEMS device 500. In one configuration, the acoustic wave path of channel segments 530 and 540 may be circular, and if the MEMS device is rotated about an axis through the area surrounded by vessel 106 in the configuration of FIG. 5, the inertia of the air or other fluid in vessel 106 will cause the acoustic wave to travel faster relative to MEMS device 500 in one rotation direction (clockwise or counterclockwise) and slower in the other rotation direction (counterclockwise or clockwise). The configuration of FIG. 5 may also have the advantages of providing a relatively long path in a smaller area and of bringing an acoustic wave with an advanced phase and an acoustic wave with a retarded phase to a single sensing diaphragm area 101B, which may simplify electronics that detects phase shifts in the acoustic waves.

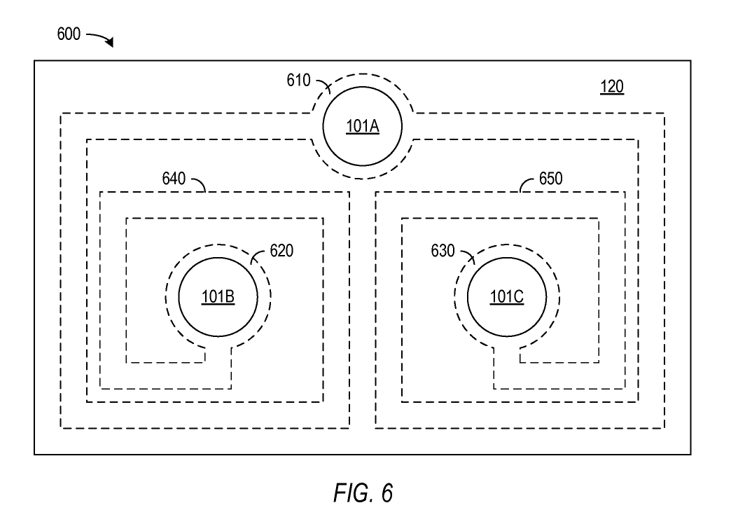

FIG. 6 shows a top view of an embodiment of a MEMS structure 600 with multiple acoustic wave conducting channel segments 640 and 650 connecting a cavity 610 associated an actuator or generator diaphragm area 101A to respective sensing diaphragm areas 101B and 101C. In the configuration of FIG. 6, each channel segment 640 or 650 provides a rectangular spiral path. Similarly to the configuration of MEMS structure 500 of FIG. 5, the non-linear paths of channel segments 640 and 650 may allow a longer channel within a smaller area MEMS device 600.

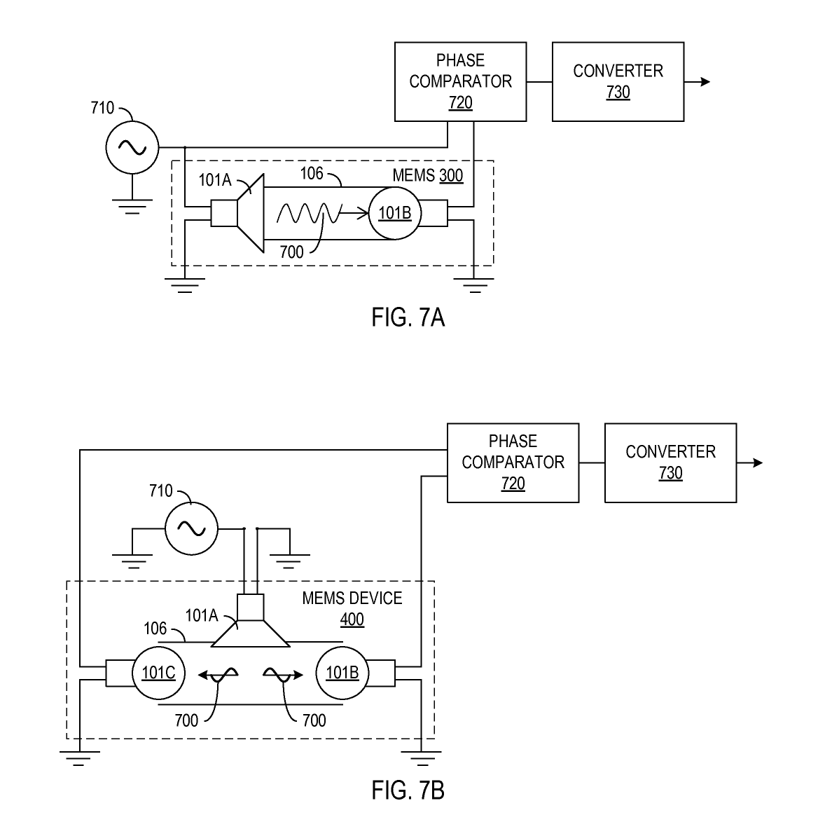

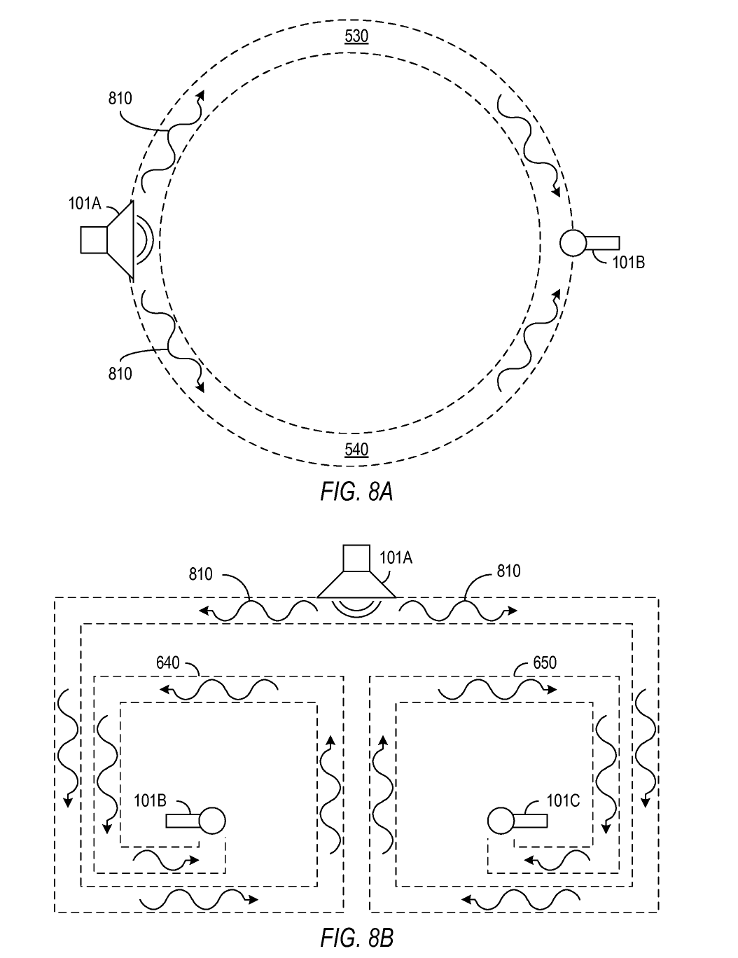

FIGS. 7A, 7B, 8A, and 8B are simplified diagrams of operating modes illustrating measurements of acoustic waves 700, which pass from an actuation diaphragm, through the wave conducting channels, and reach the sensing diaphragms. FIG. 7A shows an acoustic wave 700 passing through an acoustic wave conducting path that is a single straight channel 106 from actuating diaphragm 101A to sensing diaphragm 101B such as illustrated in FIG. 3. In operation, a source 710 of a time varying or AC signal electrically drives actuating diaphragm 101A producing acoustic wave 700 in channel 106. Acoustic wave 700 travels through air or other fluid medium that fills channel 106 and arrives at sensing diaphragm 101B with a phase that depends on movement of the MEMS device 300 containing channel 106. In particular, the velocity of the fluid relative to sensing diaphragm 101B affects the phase of the acoustic wave upon arrival at sensing diaphragm 101B, so that any motion of the MEMS device 300 that changes the velocity of the fluid relative to sensing diaphragm 101B can be detected by measuring the phase of the acoustic wave at sensing diaphragm 101B. Sensing diaphragm 101B, alone or with aid of a circuitry such as an amplifier or a capacitive sensing circuit, generates an electrical signal with a phase according to the arrival of the acoustic wave 700 at sensing diaphragm 101B. Accordingly, the electrical signal from sensing diaphragm 101B may be out of phase relative to the driving signal for actuating diaphragm 101A. A phase comparator circuit 720 determines a phase difference between the driving signal and the measured signal, and a converter 730 may determine a measurement of the movement of MEMS device 300 based on the measured phase difference. (It may be noted that although FIG. 7A shows signal source 710, phase comparator 720, and converter 730 as being separate from MEMS device 300, one or more of elements 710, 720, and 730 may be fabricated as part of the MEMS device 300, e.g., in substrate 110 or cap plate 120). In the embodiment as shown in FIG. 7A, the acoustic wave travels in straight channel 106, and the acoustic wave may arrive at the sensing diaphragm 101B either earlier or later depending on whether the traveling direction of the acoustic wave is aligned with or against the direction of the movement or acceleration of MEMS 300.

FIG. 7B shows a structure in which a MEMS device 400 includes two sensing diaphragms 101B and 101C, and acoustic wave 700 travels in opposite directions from actuating diaphragm 101A to sensing diaphragms 101B and 101C on opposite ends of wave conducting channel 106. In the system of FIG. 7B, both sensing diaphragms 101B and 101C generate sensed signals, but motion of the MEMS device 400 may cause the phase difference between the sensed signals and the driving signal to be opposite in sign because of the difference in the direction that acoustic wave 700 takes to sensing diaphragms. Phase comparator 720 in the implementation of FIG. 7B may thus compare the phases of the two sensed signals to each other and produce a measured phase difference that may be greater. In one embodiment as shown in FIG. 7B, the acoustic wave travels in two opposite directions in a straight channel. If the device has a linear motion parallel to the channel, the arrival times are different for the acoustic wave at the two sensing elements 101B and 101C on two ends of the channel 106.

FIG. 8A shows the top view of yet another embodiment wherein an acoustic wave 810 travels through a circle shape paths 530 and 540 in opposite directions and reaches the same sensing diaphragm 101B as shown in FIG. 5. In the embodiment as shown in FIG. 8A, the acoustic wave travels in a circular shape channel while in two opposite directions. If the device undergoes a rotation, one acoustic wave arrives at the sensing diaphragm 101B later when the traveling direction is the same as the device's rotational direction. Sensing diaphragm 101B detects, e.g., produces an electrical signal with, variations that indicate the phase difference between the two arriving acoustic waves, and analysis of the signal from sensing diaphragm may thus indicate a component an angular velocity of the device.

FIG. 8B shows an acoustic wave 810 traveling through two rectangular spiral shape channels 640 and 650 to reach respective sensing diaphragms 101B and 101C. In the embodiment as shown in FIG. 8B, acoustic wave 810 travels about spirals in two opposite senses, i.e., one clockwise and the other counter-clockwise. If the device experiences a rotation, the time for acoustic wave 600 to arrive at the sensing diaphragms 101A or 101B will vary, which means that the relative phase variation between the sensed signals from diaphragms 101A and 101B can be measured and a component of an angular velocity of the device can be determined.

The effect for an acoustic wave to arrive at the sensing element with a different time due to rotation is called Sagnac effect. In other words, the device rotation modulates the sensed wave phase. The phase shift is given by Δφ=8πfAω/v² where f is the acoustic wave frequency, ω is the device rotation speed, A is the area surrounded by the travel path and v is the acoustic wave traveling speed. A converter such as converter 730 of FIG. 7A or 7B may thus be programmed or hard wired to convert a measured phase difference change Δφ into a measurement of angular frequency ω, angular acceleration, or other characteristics of rotational movement.

As described above, the motion of the device causes the phase of the sensed acoustic wave signal to shift, either forward or backward. The device motion therefore modulates the signals' phase, which is sometimes called phase modulation (PM). By measuring the phase shift from sensed wave signals as described above, the motion of a device can be measured. Since most noise in a measurement system, including the electric circuit noise, is in the amplitude domain which can affect the signal's amplitude while hardly affecting the signal's phase, the PM measuring method is prone to achieve more precise measurement than the amplitude modulation (AM) method.

The MEMS devices disclosed above illustrate example configurations. Many variations and alterations are possible. For example, the number of the acoustic conducting channel segments in a MEMS structure such as an accelerometer is not limited to one or two and not limited to the few shapes illustrated in the diagrams. Each channel segment may have any desired shapes including straight, curved, circular, spiral, turned with angle, or a combination of these. The number of sensing diaphragms 101B is also not limited to one or two 101B and 101C, which are described as examples. Any number of sensing diaphragms per actuator diagram can be used in different configurations of MEMS structures. Also, the position of a sensing diaphragm 101B is not limited to being at the end of a channel or channel segment but can be either at the end of an acoustic wave conducting channel or anywhere along the path of an acoustic wave conducting channel.

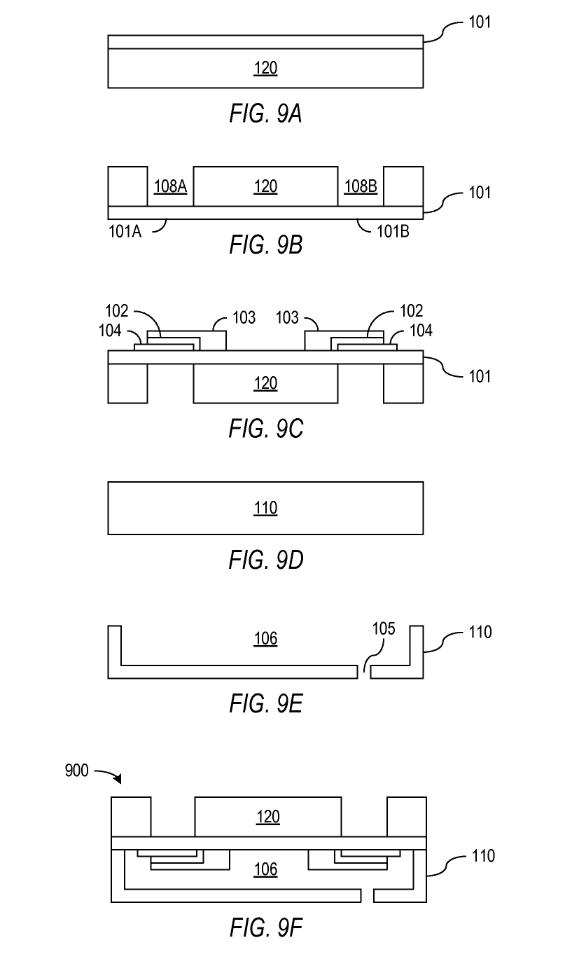

FIGS. 9A to 9F illustrate steps in a process for fabricating a MEMS structure 900, which uses piezoelectric wave generating and sensing. In the first step illustrated in FIG. 9A, a diaphragm layer 101 is deposited or otherwise formed on a substrate 120, e.g., a silicon substrate. In one implementation, diaphragm layer 101 is a silicon nitride SiN₃ layer about 0.1 μm to tens of micrometers tick. Openings 108A and 108B in substrate 120 may be then formed by a deep reactive ion etch (DRIE) that is applied to the back side of substrate 120 and leaves the previous deposited diaphragm layer 101 as flexible diaphragms 101A and 101B under openings 108A and 108B as shown in FIG. 9B. The same diaphragm layer 101 can thus serve both actuating and sensing purposes. In the next several processes, thin layers of electrode metal 104, piezoelectric material 102, and again electrode metal 103 are sequentially deposited and patterned on the diaphragm layer 101 as shown in FIG. 9C. The composite diaphragm including a region of diaphragm layer 101, first electrode 104, piezoelectric region 102, and second electrode 103 can deflect and generate an acoustic wave when a varying voltage is applied to electrodes 103 and 104. On the other hand, if acoustic wave pressure is applied, the composite diaphragm electric the piezoelectric material 102 can generate voltage signal or difference between electrodes 103 and 104. Electrically conductive traces and active electronic circuitry (not shown) may be formed on diaphragm layer 101 or substrate 120 during the processes forming the structure of FIG. 9C, for example, to provide external electrical connections to electrodes 103 and 104, to generate electrical signals applied to electrodes 103 and 104, or to amplify or process an electrical signal generated in a piezoelectric region 102.

FIG. 9D shows a separate substrate wafer 110 that is patterned and etched to form channel cavity 106 and one or more ventilation holes 105 as shown in FIG. 9E. Substrate 110 may be a silicon substrate having a thickness sufficient for the depth of channel cavity 106 but thin enough that ventilation hole may be etched through substrate 110. Substrate wafer 110 may be bonded to or fused with the cap wafer 120 to form a MEMS device 900 including a closed cavity channel 106 as illustrated in FIG. 9F.

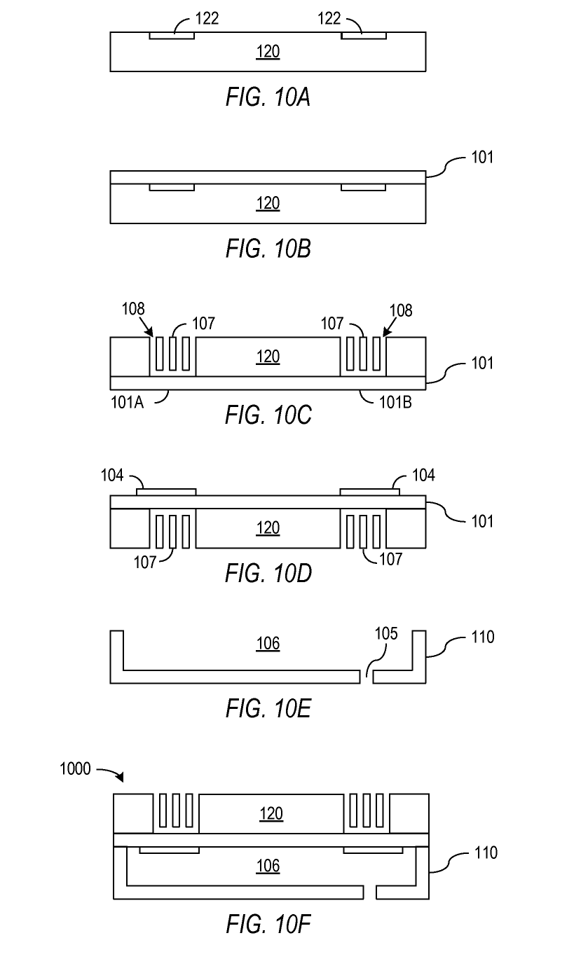

FIGS. 10A to 10F show cross-sectional views of structures created during a process for fabricating a MEMS structure 1000 that uses electrostatic driving and sensing. For this process, shallow cavities may be etched into cap wafer 120, e.g., to a depth from about 0.1 μm to a few micrometers. The cavities may then be filled with sacrificial material 122 and polished to form a flat surface as shown in FIG. 10A. A thin film of dielectric diaphragm layer 101 is deposited on the surface of substrate 120 and regions 122 of a sacrificial material as shown in FIG. 10B. The backside of cap wafer 120 may then be patterned and etched through in the areas under regions 122 to form multiple openings 108 to sacrificial regions 122. A following process step may then etch away the sacrificial material 122 to create a cavity adjacent areas 101A and 101B of the dielectric diaphragm layer 101 but leave electrode regions 107 as part of substrate 120 as shown in FIG. 10C. A thin layer of electrode metal is then deposited and patterned to form electrodes 104 on the other side of the dielectric diaphragm areas 101A and 101B as shown in FIG. 10D. An applied voltage between an electrode region 104 and adjacent electrode regions 107 associated with actuation diaphragm area 101A can thus create by an electrostatic force that deflects diaphragm area 101A. Similarly, acoustic pressure changes can deflect the diaphragm region 101B and change the capacitive coupling between the electrode region 104 associated with the sensing diaphragm 101B and the adjacent regions 107 of cap plate 120.

The bottom substrate 110 is patterned and etched to form the channel 106 and ventilation hole 105 as described above with reference to FIG. 9E and shown again in FIG. 10E. Bottom substrate 110 may then be bonded with the cap plate 120 to form the closed acoustic wave conducting channel 106 in MEMS device 1000 as shown in FIG. 10F.

As described above, the exemplary MEMS structures can generate, pass and sense acoustic waves. In particular, a drive system such as a piezoelectric drive system, an electrostatic drive system, a magnetic drive system, and a thermodynamic drive system can drive a generator diaphragm to generate an acoustic wave that travels through the channel and applies pressure that deflects the sensing diaphragm. Motion of the sensing diaphragm may then be measured to determine a phase shift of acoustic waves as received at the sensing diaphragm. The phase shift measurements may be less prone to noise than are measurements of the amplitude of motion MEMS structures, so that conversion of a phase shift measurement can provide accurate measurements of acceleration or rotation of a MEMS structure.

What is claimed:

1. A sensor comprising:
an acoustic wave channel;
a first diaphragm that is drivable to generate waves in the acoustic wave channel; and
a second diaphragm configured to oscillate in response to acoustic waves reaching the second diaphragm through the acoustic wave channel.

2. The sensor of claim 1, wherein the first diaphragm comprises one of a piezoelectric drive system, an electrostatic drive system, a magnetic drive system, and a thermodynamic drive system.

3. The sensor of claim 1, wherein the first diaphragm comprises a layer of material selected from the group consisting of semiconductors, dielectrics, metals and metal alloys, silicon, silicon dioxide (SiO₂), silicon nitride (Si₄N₃), Cu, Al, Ag, Ti, W, Au, Pt, Ni, and Zn.

4. The sensor of claim 1, wherein one side of the first diaphragm comprises a layer of a piezoelectric material selected from the group consisting Aluminum Nitride, Lead Zirconate Titanate, Zirconium Oxide, Silicon Carbide, Silicon Nitride, Silicon Alumina Nitride, and Aluminum Titanate.

5. The sensor of claim 1, wherein the acoustic wave channel comprises a substrate having a cavity shaped to conduct acoustic waves from the first diaphragm to the second diaphragm.

6. The sensor of claim 5, wherein the cavity is filled with fluid as acoustic wave conducting medium.

7. The sensor of claim 5, wherein the cavity includes one or more segments, each segment having a shape selected from a group consisting of straight, circular, curved, spiral, and turned with an angle.

8. The sensor of claim 5, further comprising a plurality of sensing diaphragms including the second diaphragm, wherein the cavity conducts acoustic waves from the first diaphragm to each of the sensing diaphragms.

9. The sensor of claim 8, wherein:
the second diaphragm is at a first end of the acoustic wave channel;
another of the sensing diaphragms is at a second end of the acoustic wave channel, and
the first diaphragm is between the first end and the second end.

10. The sensor of claim 5, wherein the substrate including the cavity is made of a material selected from a group consisting of semiconductors, dielectrics, and metals.

11. A method for inertial measurement comprising:
generating an acoustic wave using an first diaphragm in a MEMS device;
passing the acoustic wave from the first diaphragm through a channel in the MEMS device to a second diaphragm; and
measuring a phase of the acoustic wave at the second diaphragm after the acoustic wave passes through the channel.

12. The method of claim 11, wherein the acoustic wave has a frequency in a range from 1 kHz to 1 GHz.

13. The method of claim 12, wherein the first diaphragm generates the acoustic wave using a piezoelectric force, an electrostatic force, a magnetic force, a thermal dynamic force, or a combination of two or more of these.

14. The method of claim 12, further comprising passing the acoustic wave through multiple channels.

15. The method of claim 14, wherein the acoustic wave is sensed by multiple sensing diaphragms.

16. The method of claim 11, wherein movement of the MEMS device modulates a phase of the acoustic wave where measured.
